(19) United States
(12) Patent Application Publication
(10) Pub. No.: US 2009/0263006 A1
(43) Pub. Date: Oct. 22, 2009

(54) BIOCHIP INSPECTING DEVICE AND BIOCHIP INSPECTING METHOD

(75) Inventors: Yasunori Suzuki, Musashino-shi (JP); Takeo Tanaami, Musashino-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/424,097

(22) Filed: Apr. 15, 2009

(30) Foreign Application Priority Data
Apr. 22, 2008 (JP) 2008-110881

(51) Int. Cl. G06K 9/00

(52) U.S. Cl. 382/151

(57) ABSTRACT

There is provided a biochip inspecting device capable of showing a manifestation state as a graphical display that can be intuitively grasped. Reading means optically reads respective sites over a biochip, on the basis of an imaging signal from an optical reader. Digitizing means digitizes manifestation states in respective sites on the basis of results of reading by the reading means. Scaling means scales the numerical values of the respective sites acquired via the digitizing means. Image-outputting means outputs an image (a graphical chip image) obtained by disposing spot images having gradation values acquired via the scaling means at respective positions specified on a site-by-by-site basis.

### FIELD OF THE INVENTION

The invention relates to a biochip inspecting device for outputting results of inspection on a biochip as optically read, and a biochip inspecting method.

### BACKGROUND OF THE INVENTION

There have been known techniques, for example as disclosed in JP 2005-308504A, whereby a biochip, such as a chip or a microarray, and so forth, for detecting DNA, RNA, protein, sugar chain, metabolome, and so forth, is read by a biochip reader to perform an analysis on the basis of an image as obtained. A plurality of sites corresponding to respective target molecules are disposed at a given reference pitch in an x-y plane within the biochip, and fluorescent intensity of each of the sites on the image is grasped as a manifestation state of each of the target molecules correspond thereto.

In the case of numerical analysis of the biochip, attention is focused on gradation values in regions of the respective sites, and a statistical value such as, for example, a mean value, or a central value of gradation values of pixels contained in each of the regions is derived as an analysis value. If there is the need for grasping the manifestation state of the chip in its entirety, numerical data indicating a list of the analysis values for the respective sites will be acquired as the results of analyses.

However, even if the numerical data are watched, this will not enable the manifestation state of the chip in its entirety to be intuitively grasped. Further, even if the image of the biochip, as read by the biochip reader, is watched, there can be a case where it is not possible to establish a link between a numerical value such as a mean value of simple gradation, and so forth, with visually-sensed brightness at a site on the image because nonuniformity, deformation, bright spots, and so forth are present on the image of the site in reality. Accordingly, it is highly desirable to develop a system capable of showing the manifestation state that is hard to be grasped by merely displaying the numerical data or the image of a biochip alone as a graphical display that can be intuitively grasped.

### SUMMARY OF THE INVENTION

It is therefore an object of the invention to provide a biochip inspecting device capable of showing a manifestation state as a graphical display that can be intuitively grasped.

In accordance with one aspect of the invention, there is provided a biochip inspecting device for outputting results of inspection on a biochip as optically read, said biochip inspecting device comprising reading means for optically reading respective sites over the biochip, digitizing means for digitizing manifestation states of the respective sites on the basis of the results of reading by the reading means, and image-outputting means for outputting an image obtained by disposing a display indicating numerical values of the respective sites, acquired via the digitizing means, at respective positions specified on a site-by-by-site basis.

With the biochip inspecting device according to the invention, since the image obtained by disposing the display indicating the numerical values of the respective sites, acquired via the digitizing means, at the respective positions specified on the site-by-by-site basis, is outputted, it is possible to acquire a graphical display whereby a manifestation state can be intuitively grasped.

The biochip inspecting device may further comprise scaling means for scaling the numerical values of the respective sites, acquired via the digitizing means, to be delivered to the image-outputting means.

The scaling means may comprise receiving means for receiving definition of algorithm for scaling in the scaling means.

The biochip inspecting device may output the image, as the display indicating the numerical values of the respective sites, acquired via the digitizing means, wherein spot images having the numerical values acquired via the digitizing means, as respective gradation values, are disposed at the respective positions specified on the site-by-by-site basis.

The spot images may be disposed in the same way as the respective sites are disposed on the biochip.

In accordance with another aspect of the invention, there is provided a biochip inspecting method for outputting results of inspection on a biochip as optically read, said biochip inspecting method comprising a reading step for optically reading respective sites over the biochip, a digitizing step for digitizing manifestation states of the respective sites on the basis of the results of reading via the reading step, and an image-outputting step for outputting an image obtained by disposing a display indicating numerical values of the respective sites, acquired via the digitizing step, at respective positions specified on a site-by-by-site basis.

With the biochip inspecting method according to the invention, since the image obtained by disposing the display indicating the numerical values of the respective sites, acquired via the digitizing step, at the respective positions specified on the site-by-by-site basis, is outputted, it is possible to acquire a graphical display whereby a manifestation state can be intuitively grasped.

The biochip inspecting method may further comprise a scaling step for scaling the numerical values of the respective sites, acquired via the digitizing step, and delivering the scaled numerical values to the image-outputting step.

With the biochip inspecting device according to the invention, since the image obtained by disposing the display indicating the numerical values of the respective sites, acquired via the digitizing means, at the respective positions specified on the site-by-by-site basis, is outputted, it is possible to acquire a graphical display whereby a manifestation state can be intuitively grasped.

With the biochip inspecting method according to the invention, since the image obtained by disposing the display indicating the numerical values of the respective sites, acquired via the digitizing step, at the respective positions specified on the site-by-by-site basis, is outputted, it is possible to acquire a graphical display whereby a manifestation state can be intuitively grasped.

### BRIEF DESCRIPTION OF THE DRAWINGS

FIG. 1 is a block diagram showing a configuration of a biochip inspecting device according to an embodiment of the invention;

FIG. 2 is a flow chart showing operation procedures of the biochip inspecting device; and

FIG. 3(A) to 3(C) are views showing a graphical chip image, wherein FIG. 3(A) is a view showing a base image, FIG. 3(B) is a view showing an image during drawing and FIG. 3(C) is a view showing an image after completion of drawing.

### BEST MODE FOR CARRYING OUT THE INVENTION

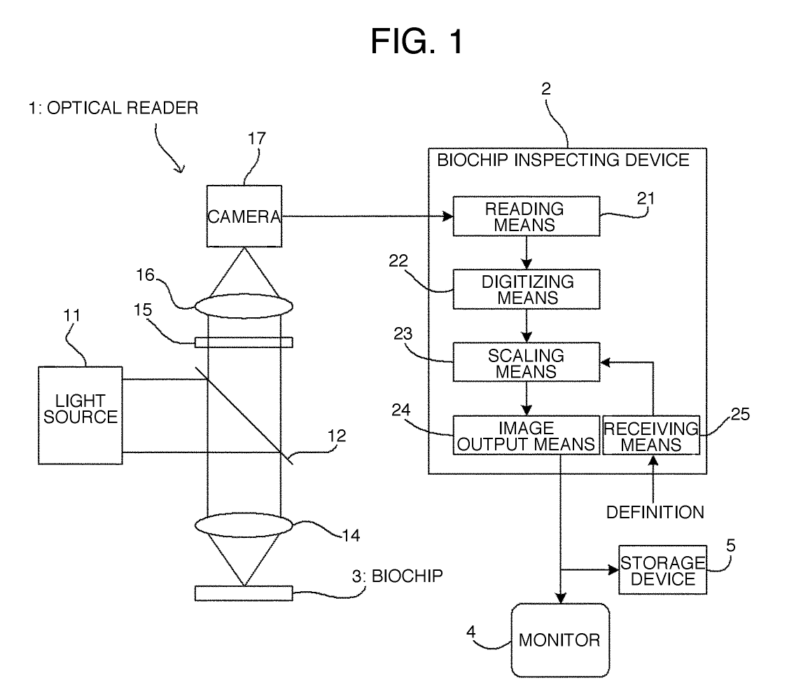

The biochip inspecting device and biochip inspecting method according to the invention are now described with reference to FIGS. 1 to 3.

FIG. 1 is a block diagram showing a configuration of a biochip inspecting device according to an embodiment of the invention.

As shown in FIG. 1, a biochip inspecting device 2 receives an imaging signal from an optical reader 1 for reading fluorescent light beam from a biochip 3 and outputs results of inspection. Circular sites are disposed over the surface of the biochip 3 at intervals in conformance with a given reference pitch within a two-dimensional surface of the biochip.

The optical reader 1 comprises a light source 11, a dichroic mirror 12 which refracts light from the light source 11, an objective lens 14, a filter 15 for causing fluorescent light beam from the biochip 3 to pass selectively therethrough, a lens 16 and a camera 17.

The biochip inspecting device 2 comprises reading means 21 for optically reading respective sites over the biochip 3, on the basis of the imaging signal from the optical reader 1, digitizing means 22 for digitizing manifestation states in respective sites on the basis of results of reading by the reading means 21, scaling means 23 for scaling the numerical values of the respective sites acquired via the digitizing means 22, image-outputting means 24 for outputting an image (a graphical chip image) obtained by disposing spot images having gradation values acquired via the scaling means 23 at respective positions specified on a site-by-by-site basis, receiving means 25 for receiving definition of algorithm for scaling by the scaling means 23. The image outputted from the image-outputting means 24 is displayed on a monitor 4 and stored in a storage device 5.

Operations of the optical reader 1 and biochip inspecting device 2 are described next.

Excitation light from the light source 11 of the optical reader 1 passes through the dichroic mirror 12 and objective lens 14, and is irradiated onto the biochip 3. Fluorescent light as excited by the excitation light in respective sites over the biochip 3, passes through the objective lens 14, dichroic mirror 12, filter 15, lens 16 and falls on the camera 17. An optical image of the biochip 3 is focused onto an imaging face of the camera 17.

An imaging signal outputted from the camera 17 is supplied to the biochip inspecting device 2.

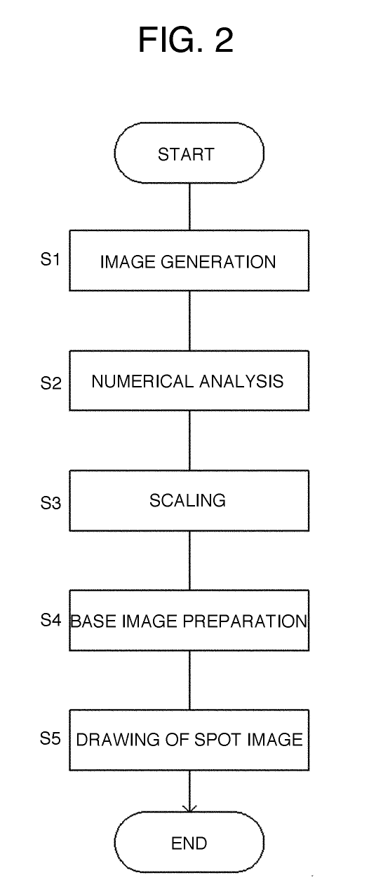

FIG. 2 is a flow chart showing operation procedures of the biochip inspecting device 2.

In Step S1 in FIG. 2, an image of the biochip 3 (hereinafter referred to as biochip image) is generated on the basis of the imaging signal outputted from the camera 17 in the reading means 21 of the biochip inspecting device 2.

Next in step S2, a numerical analysis of respective sites is performed in the digitizing means 22 on the basis of the biochip image thus generated in the reading means 21. In the numerical analysis processing, barycentric positions of respective sites are found on the basis of the biochip image, and mean gradation values of pixels within respective circular regions each having a prespecified diameter are found around the barycentric positions. Meanwhile, the reason why the barycentric positions are found is that the positions of respective sites in reality are deviated from the above-described reference pitch when preparing the biochip 3.

Next in step S3, the mean gradation values found by the digitizing means 22 undergo scaling by the scaling means 23. Details of the scaling by the scaling means 23 are described later.

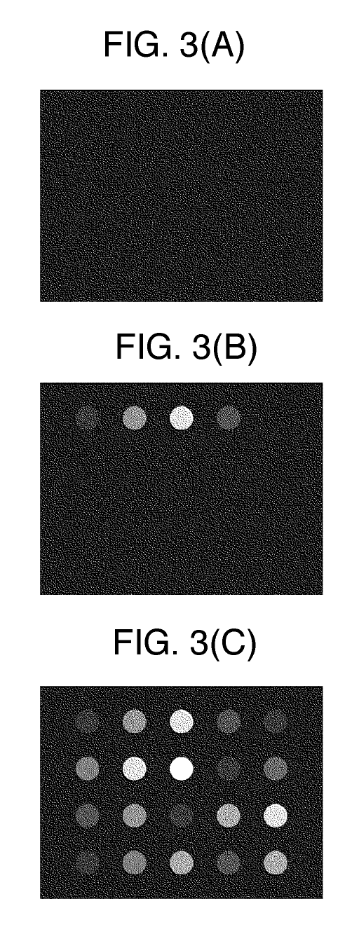

Next in step S4, a base image which forms a base of a graphical chip image shown in FIG. 3(A) is prepared by the image-outputting means 24. The base image is an image wherein the gradation values of all pixels in the areas of the biochip 3 in its entirety are zero. Meanwhile, a format of the graphical chip image may be the same as that of an original biochip image. For example, if the original biochip image is a 16-bit gray scale Tiff image, a graphical chip image having the same format is sufficient to be generated.

Next in step S5, spot images having gradation values acquired on the basis of scaling by the scaling means 23 are drawn on the base image of the graphical chip image prepared by the image-outputting means 24. FIG. 3(B) is a view showing an image during drawing and FIG. 3(C) is a view showing an image after completion of drawing. The spot images correspond to the respective sites over the biochip 3 and drawing positions of the spot images are predefined. According to the examples in FIG. 3(B) and FIG. 3(C), the spot images are disposed at equally-spaced intervals in conformance with a given reference pitch of the sites over the original biochip 3. The gradation values of respective pixels of the individual spot images are uniform across the entire pixel, and the individual spot images have no nonuniformity differing from the original biochip image. Image data of the graphical chip image as drawn are stored from time to time in the storage device 5, and a series of procedure end.

A technique of scaling and so forth by the scaling means 23 are described next.

A format of a graphical chip image may be different from that of an original biochip image. For example, if the original biochip image is 16-bit gray scale Tiff image, it is possible to generate a graphical chip image of a 8-bit gray scale Tiff image by scaling. Further, a 14- or 12-bit gray scale Tiff image may be selected as a graphical chip image, and a multi-valued image format other than the Tiff image may be selected as the format of the graphical chip image.

Gradation can be enlarged or compressed by scaling. For example, a gradation width may be enlarged so that the gradation of the spot image of the site indicating the maximum gradation value in the original biochip image is fully scaled. Alternatively, the gradation width may be enlarged so as to emphasize only a change in a specific gradation value. On the contrary, the gradation may be compressed. If gradation having 16 bits or 48 bits at maximum which is too large in dynamic range to be hard to be visually grasped or represented is compressed, e.g. to 8 bit, it is possible to visually grasp the gradation on one screen in its entirety. Further, necessary range of gradation representation can be narrowed by discarding an unnecessary gradation range. Still further, gradation may be compressed by converting the numerical value to a logarithm.

It is possible to employ, for example, a technique of scaling gradation of a spot image of a site indicating the maximum gradation value in the original biochip image to a value which is prespecified by a user or a technique of scaling gradation of a spot image of a specific site to a value which is prespecified by a user. In these cases, the use can specify either of the techniques of scaling via the receiving means 25 (FIG. 1).

Gamma correction of an image may be performed by scaling.

The gradation values of the spot images may be statistical values other than the mean gradation values. For example, the gradation values of the spot images may be a central value, a maximum value or a minimum value of the gradation values of respective sites. Further, individual graphical chip-images prepared by different statistical values may be put into one file using a multipage function.

A procedure to generate the graphical chip image can be appropriately selected. For example, the procedure comprises preparing an array of a size, in which image information that is the same as the original biochip image can be stored, in an initialized state on a program, setting respective gradation values to the array at positions corresponding to pixels of respective spot images of the graphical chip image by operating the array, and finally storing the array having pixel information in a desired image format.

The method of disposing spot images of the graphical chip image is optional, and it may be different from that of the original biochip image. For example, if respective sites each having the same target molecules are repeated, spot images of a plurality sites are disposed together at continuous positions, or mean values and the like of the sites repeated as one spot image may be indicated. Further, necessary sites alone are extracted from the sites provided over the biochip so as to display spot images on the necessary extracted sites. Further, the sites are extracted for every inspection (e.g. type of disease), and only the spot images corresponding to the extracted site may be displayed. Still further, spot images may be selectively displayed only on sites which exceeds a statistical level of significance.

Positions where the spot images of the graphical chip image are disposed may be set at positions which are always determined for every kind of chips, i.e. always determined on a chip-by-chip basis.

Further, the shape of the spot image is not limited to a circular one, but it may be square or triangular. Still further, the shape or size of the spot image may be different from that of the site over the original biochip. Still further, if the shape of a region used when performing a numerical analysis is different from that of the site, the shape of the spot image may be the same as the shape of the region when performing the numerical analysis.

In the case of a graphic chip image, respective spot images may undergo a multi-valued image by a pseudocolor display. Further, a gray display and pseudocolor display may be switchable therebetween.

The invention may be applied to a method of performing measurement of a biochip while setting a plurality of exposure times, and employing digitized results using an image with an optimum exposure time for analysis of respective sites when performing a numerical analysis (JP2005-308504A). When applying the invention to this method, a graphical composite chip image is generated using the image with an optimum exposure time for analysis of the respective sites. In this case, as the mean gradation values applied to regions of the spot images, there are employed values found by converting the means gradation values for respective exposure times, e.g. to those for one second exposure time, and multiplying by a scale factor. Here, as the scale factor, it is possible to select a value to scale such that the maximum mean gradation value of the chip converted to that for one second exposure time becomes the maximum gradation value in the image format to be stored, a value to scale such that the maximum mean gradation value of the chip converted to that for one second exposure time becomes a value prespecified by a user, or a value to scale such that a spot image of the site prespecified by the user becomes values prespecified by the user, and so forth.

The image outputted by the image-outputting means 24 is not limited to the image displaying manifestation states in respective sites by the gradation values of the spot images. For example, the image may be displayed by a three-dimensional bar graph. In this case, X-Y coordinate corresponds to those of sites, or numbers of columns and rows of the sites while a Z coordinate thereof becomes statistical values such as mean gradation values or the like. At this time, the results of analysis at the same site in different chips can be indicated as a plurality of bar graphs prepared at a region corresponding to that site. Further, the results of analysis at the same site in different chips can be put into one bar graph as indicating mean values.

As mentioned above, according to the biochip inspecting device of the invention, a graphical chip image is reconstructed on the basis of numerically analyzed data. Accordingly, as the data after completion of numerical analysis is graphically displayed as a manifestation state of the biochip, the manifestation state can be grasped easily and intuitively compared with a case where results of numerical analysis are viewed as numerical data.

Further, because nonuniformity, deformation, bright spots, and so forth are present on the spot of the biochip image in reality, in the case where the manifestation state is confirmed by checking the numerical values and the original biochip image, a user has to determine and consider information necessary for establishing a link with the numerical data. However, according to the biochip inspecting device of the invention, since the graphical chip image is based on the statistical values (numerical data) such as mean gradation values, a consistency between the results of numerical analysis and the graphical chip image is high, and hence the manifestation state of the measured biochip can be grasped intuitively.

Further, in the case where spot images are disposed two-dimensionally to display the numerical values by that gradations thereof, a multitude of data can be grasped intuitively, compared, e.g. with a graph display and so forth.

Still further, the image obtained by disposing the spot images two-dimensionally takes a configuration common to the original biochip image. Accordingly, a conventional system for performing a numerical analysis by reading a biochip image, for example, a digitizing software of a microarray can be utilized as it is. That is, if the graphical chip image is loaded into that system, an analysis by the same system can be likewise performed. Still further, if a graphical chip image data is loaded into other statistical image processing software, an analysis by the same software can be also performed.

A scope of application of the invention is not limited to the embodiment as described above. The invention can be widely applied to a biochip inspecting device for outputting the result of inspection on a biochip as optically read and a biochip inspecting method.

What is claimed is:

1. A biochip inspecting device for outputting results of inspection on a biochip as optically read, comprising:
reading means for optically reading respective sites over the biochip;
digitizing means for digitizing manifestation states of the respective sites on the basis of the results of reading by the reading means; and
image-outputting means for outputting an image obtained by disposing a display indicating numerical values of the respective sites, acquired via the digitizing means, at respective positions specified on a site-by-by-site basis.

2. The biochip inspecting device according to claim 1, further comprises scaling means for scaling the numerical values of the respective sites, acquired via the digitizing means, to be delivered to the image-outputting means.

3. The biochip inspecting device according to claim 2, further comprises receiving means for receiving definition of algorithm for scaling in the scaling means.

4. The biochip inspecting device according to any one of claims 1 to 3, wherein the image is outputted, as the display indicating the numerical values of the respective sites, acquired via the digitizing means, wherein spot images having the numerical values acquired via the digitizing means, as respective gradation values, are disposed at the respective positions specified on the site-by-by-site basis.

5. The biochip inspecting device according to claim 4, wherein the spot images may be disposed in the same way as the respective sites are disposed on the biochip.

6. A biochip inspecting method for outputting results of inspection on a biochip as optically read, comprising:
a reading step for optically reading respective sites over the biochip;
a digitizing step for digitizing manifestation states of the respective sites on the basis of the results of reading via the reading step; and
an image-outputting step for outputting an image obtained by disposing a display indicating numerical values of the respective sites, acquired via the digitizing step, at respective positions specified on a site-by-by-site basis.

7. The biochip inspecting method according to claim 6, further comprises a scaling step for scaling the numerical values of the respective sites, acquired via the digitizing step, and delivering the scaled numerical values to the image-outputting step.
